(19) United States
(12) Patent Application Publication
(10) Pub. No.: US 2006/0203730 A1
(43) Pub. Date: Sep. 14, 2006

(54) Method and system for reducing end station latency in response to network congestion

(76) Inventor: Uri El Zur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/356,390

(22) Filed: Feb. 15, 2006

Related U.S. Application Data
(60) Provisional application No. 60/662,068, filed on Mar. 14, 2005.
(60) Provisional application No. 60/750,245, filed on Dec. 14, 2005.

(51) Int. Cl. H04J 1/16; H04L 12/56

(52) U.S. Cl. 370/235; 370/395.43

(57) ABSTRACT

Methods and systems for processing network data are disclosed herein and may include receiving from a switching device, a congestion indicator that indicates congestion. In response to the congestion indicator, latency of reaction by a source end point, may be reduced by preventing introduction of queued up new frames to affected flow or CoS before the local stack adjusts its rate to congestion conditions and/or by rate limiting the processing of unprocessed network frames in hardware. The unprocessed network frames may include unprocessed network frames of a particular type. In response to the received congestion indicator, by a destination end point, congestion indicator flags may be set in processed network frames of the particular type, faster than an expected reaction of a local stack. The congestion indicator flags may be explicit congestion notification (ECN)-Echo flags.

### CROSS-REFERENCE TO RELATED APPLICATIONS/INCORPORATION BY REFERENCE

This application makes reference to, claims priority to, and claims the benefit of:
U.S. Provisional Application Serial No. 60/662,068, filed Mar. 14, 2005; and
U.S. Provisional Application Serial No. 60/750,245, filed Dec. 14, 2005.

The above stated applications are hereby incorporated herein by reference in their entirety.

### FIELD OF THE INVENTION

Certain embodiments of the invention relate to communication networks. More specifically, certain embodiments of the invention relate to a method and system for reducing end station latency in response to network congestion.

### BACKGROUND OF THE INVENTION

A network may comprise a plurality of end points (EPs) and a plurality of switches and/or routers. These switches and routers have limited resources to store frames that are being switched or routed from their source to their destination(s). During routing, congestion may happen as a result of a temporary shortage of buffers in a switch or a router. As a result of this congestion, these routers and switches may drop frames due to the temporary shortage of buffers. For example, over subscription or over-use of an output port may result in dropped frames due to congestion. Multiple EPs, for example M clients, may send data to one EP such as a server. If all or a large portion of the EPs use the same data rate, then traffic at ingress may be up to M times a link bandwidth, but the egress link bandwidth may be limited to a number smaller than M, such as 1 times the link bandwidth. A switch or router will buffer excess data but eventually will run out of buffers if the offered load is much greater than an amount of data that the switch has the capability to drain or to buffer. This type of problem is important for networks comprising applications that are sensitive to latency or to data loss. Exemplary networks may include cluster networks such as High Performance Computing HPC utilizing Remote DMA (RDMA) or other mechanisms, and storage networks such as iSCSI, and other real time networks, such as voice over IP (VoIP) networks.

Convergence of multiple data types on one Ethernet wire, which may occur, for example in a server blade, requires better guarantees or assurance for latency and loss. RFC 3168 provides a way for communicating congestion information at IP and TCP protocol layers. It uses switches/routers driven detection (e.g. Random Early Detect RED or other) to create events that signal the EPs to slow down before switch/router buffers are full and to prevent frame drop as a result of buffer overrun. However, the solution proposed by RFC 3168 relies primarily on some level of buffering in the network to accommodate the control loop delay or a short control loop for a shallower buffering levels and it works only if the time it takes from indication to the EP slowing down is short enough, given some buffer levels when first switch/router originated indication is sent. Higher data speeds, for example 10 Gbits/sec, may impose yet higher requirements for a shorter control loop or for deeper buffers that are expensive and in some cases financially impractical. Coupled with some latencies in the EPs, it may be sufficiently high to render this early indication prior to dropping packets suboptimal or in certain instances unworkable.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for reducing end station latency in response to network congestion, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating congestion indication and reaction utilizing a network destination device, in accordance with an embodiment of the invention.

FIG. 2 is a diagram illustrating exemplary fast congestion handling on the destination side, such as in a network destination device (NDD) NIC, for example, in accordance with an embodiment of the invention.

FIG. 3 is a block diagram illustrating handling of congestion notification for L3/L4 frames, in accordance with an embodiment of the invention.

FIG. 4 is a block diagram illustrating handling of congestion notification for L2 frames, in accordance with an embodiment of the invention.

FIG. 5 is a diagram illustrating congestion indication and reaction without a network destination device, in accordance with an embodiment of the invention.

FIG. 6 is a diagram illustrating an exemplary fast congestion handling source such as a network source device (NSD), in accordance with an embodiment of the invention.

FIG. 7 is a block diagram of exemplary congestion filter, in accordance with an embodiment of the invention.

FIG. 8 is a flow diagram illustrating exemplary steps for processing network data, in accordance with an embodiment of the invention.

### DETAILED DESCRIPTION OF THE INVENTION

Certain embodiments of the invention may be found in a method and system for reducing end station latency in response to network congestion. Congestion indication indicating network traffic congestion may be communicated from a switching device to a network source device and/or to a network destination device. In response to the received congestion indication, a network destination device may set congestion indication flags, such as explicit congestion notification (ECN)-Echo flags, in network frames being sent to the network source device on the same flow, such as TCP ACK frames, in instances when L3/L4 signaling is used. The network frames with set congestion indication flags may be communicated to a network source device. Latency may then be reduced within the network source device by taking an immediate action of reducing the rate or rate limiting the transmission of to-be transmitted network frames that are part of the TCP flow or Class of Service signaled in hardware, based on the received network frames with set congestion indication flags. A congestion indication, such as a congestion window reduced (CWR) flag, indicating a reduction in congestion of the unprocessed network frames may be set in hardware in outgoing frames that are part of the same flow and are send to the network destination device, indicating the source has taken action on the congestion indicated. In response to the congestion indication indicating a reduction in congestion, a control bit may be set within processed network frames corresponding to unprocessed network frames. Processing speed for unprocessed network frames may be adjusted based on the control bit.

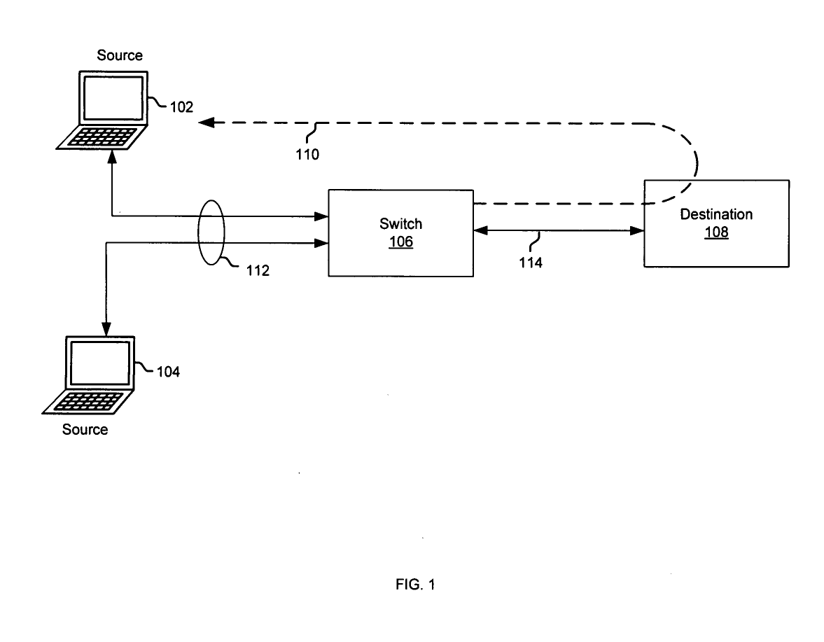

FIG. 1 is a diagram illustrating congestion indication and reaction utilizing a network destination device, in accordance with an embodiment of the invention. Referring to FIG. 1, there are illustrated network source devices 102 and 104, a network switch 106, and a network destination device 108. The network source devices 102 and 104 may be PC devices or servers or any other device connected to the network and the destination device 108 may be a network server, or another device. The network switch 106 may comprise suitable circuitry, logic, and/or code and may be adapted to receive network signals 112 from both network source devices 102 and 104, and output a network signal 114 selected from the network signals 112.

In operation, the network switch 106 may experience congestion due to, for example, limitations in the bandwidth of the output network signal 114 or limited buffering capabilities or both. As a result, the network switch 106 may generate a congestion indication 110, which may be communicated to a stack on the network destination device 108 where it may be processed. The congestion indication 110 may then be communicated back to a network source device, such as the network source device 102. With regards to the network destination device 108, its latency reacting to the congestion indication may be determined from the sum of the latency experienced on the receive (Rx) side of the network destination device 108, the latency of its communication stack processing and latency experienced on the transmit (Tx) side of the network destination device 108, including pipelining of frames in each direction. The congestion indication 110 may then be send over the network, experience the latencies and potential congestion on the network including all switches and routers or other devices in its path before it can be received at the network source device 110b.

With regard to the network source device, the latency may comprise the latency on the receive side of the network source device 102, latency associated with stack processing within the network source device 102, latency associated with taking remedial action, such as reduction in processing speed or in reduction of rate for the particular flow or class, and latency from the transmit side of the network source device 102, including pipelining. In this regard, previous frames for the same destination or contributing to the congestion point or points may have already been pipelined before along with potentially other frames. The total latency form the indication by the switch/router, where the congestion was detected, to the reduction in traffic on the congested path as seen by that switch 106 may include forward propagation to the destination 108 (including internal switch 106 latencies and the network and other devices between the switch 106 and the destination device 108), destination device 108 latencies mentioned above, propagation delay in the network between destination 108, and source 103 including all devices in the path, source device 102 latencies in processing the request (as mentioned above), and time to drain the affected resource after source reduces its rate. This may constitute an example for Forward Explicit Congestion Notification mechanism (FECN).

In an exemplary embodiment of the invention, end point (EP) response time to congestion events, such as response time to congestion events received by the network destination device 108, for example, may be significantly reduced by reducing latency of the network destination device 108 during processing of congestion indication received from the network switch 106. An EP may be a device that has the role of turning back to a network source, a congestion indication sent at any layer of the network, as a Forward congestion notification. The EP may signal the network source using network signals. It may also update its local communication stack, if present in hardware or update its host resident stack. The latency of the network destination device 108 may be reduced by immediately forwarding the congestion indication by hardware mimicking expected behavior by the relevant networking layer (where signaling happens or state is updated or both), or fully executing that behavior in hardware and updating the state at the right networking or protocol layer. In data center environments, the EPs latencies may be a significant contributor to the total latency of the control and data paths.

In one embodiment of the invention, the hardware may mimic TCP behavior with hardware (HW) latencies, instead of latencies of the receive side of the destination device 108, the latencies of the TCP stack on 108 and the latencies of the network traffic which is already queued up and ready for transmission by the network destination device 108. For example, the network destination device 108 may detect congestion within received network traffic and may generate corresponding congestion indication in, the first opportunity it has, with network traffic queued for transmission. In this regard, congestion indication 110 on the transmit side of the destination device 108 may be generated after congestion indication is detected on the received network traffic of 108 and prior to any processing of the received network data by the TCP stack on 108. The congestion indication 110 may then be communicated to the network source device 102, for example. The network source device 102 may adjust processing speed for unprocessed network frames or change its rate of emitting new frames of relevant flow or class of service to the congested network, based on the received congestion indication 110.

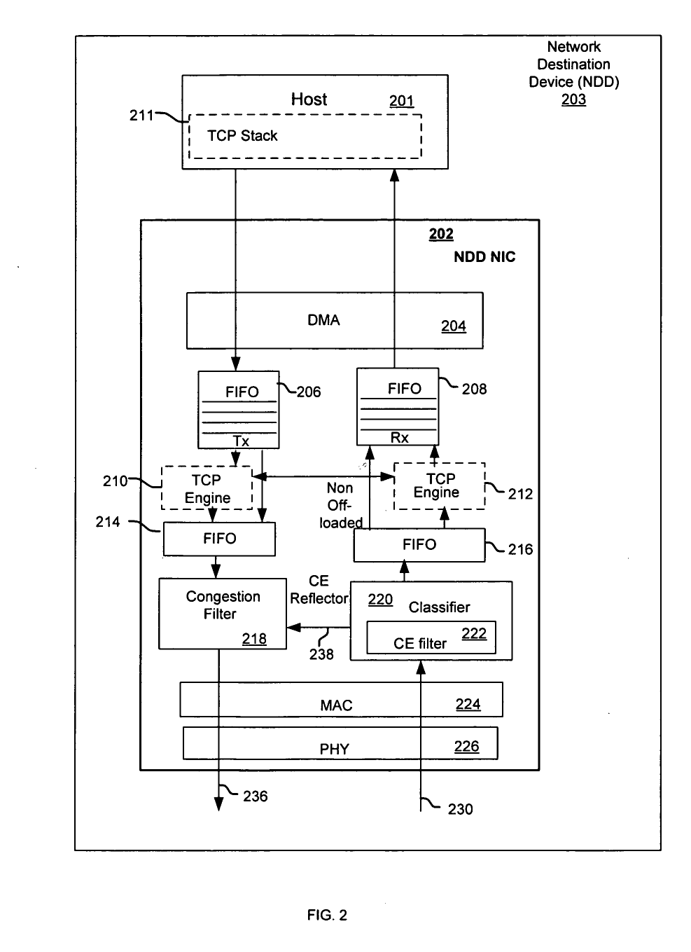

FIG. 2 is a diagram illustrating exemplary fast congestion handling on the destination side, such as in a network destination device (NDD) NIC, for example, in accordance with an embodiment of the invention. Referring to FIG. 2, the NDD NIC 202 may be implemented within a network destination device (NDD) 203, for example, and may comprise a network protocol stack for processing network data. The NDD NIC 202 may comprise a physical layer (PHY) block 226, a data link layer or media access control (MAC) block 224, a classifier block 220, which may or may not be integrated with the MAC, first-in-first-out (FIFO) buffers 206, 208, 214, and 216, TCP engine blocks 210 and 212, a congestion filter 218, which may or may not be integrated with the MAC, and a direct memory access (DMA) block 204. The classifier block 220 may comprise a congestion experience (CE) filter 222. The TCP engines 210 and 212 may be shared between transmit and receive side, and some of the FIFO may or may not be used. The TCP processing may be on the host in case a Layer 2 NIC is used.

The classifier block 220 may comprise suitable circuitry, logic, and/or code and may be adapted to parse incoming network frames. In instances when the NDD NIC 202 owns TCP flows, the classifier may be also employed with matching incoming network frames with one or more active connections owned by the NDD NIC 202. The CE filter 222 may comprise suitable circuitry, logic, and/or code and may be adapted to filter congestion indications, such as CE bits or CWR bits in the IP or TCP headers, or option fields within incoming network frames. The CE filter 222 may also communicate the congestion indications along with a connection or flow identifier or class of service identifier or both to the congestion filter 218 on the transmit side, using 238. Such an identifier may be a TCP/IP four-tuple, including IP source and destination addresses as well as TCP source and destination ports, it may be or also include IEEE802.1P, 802.1Q class, and/or IP TOS bit setting. The congestion filter 218 on the transmit side, may comprise suitable circuitry, logic, and/or code and may be adapted to filter for frames associated with the connection or flow or class as provided by the CE filter 222 and generate congestion indications within processed network frames, which are ready to be transmitted, setting appropriate bits in the outgoing frames.

In operation, received network data 230 may be initially processed by the PHY block 226 and by the MAC block 224. The CE filter 222 within the classifier block 220 may then detect congestion indication on the received network data 230. The CE filter 222 may then consult one or more policies before forwarding to the transmitter. Such policies may include priorities for flows, flows association with QoS or CoS, flows offloaded to the NDD NIC 202, if it is TCP capable, and/or QoS or SLA guarantees for particular flows. In instances when the CE filter 222 forwards the detected congestion indication 238, it may add along with it, a flow or CoS identifier to the congestion filter 218 on the transmit side of the NDD NIC 202. The congestion filter 218 may set congestion indication flags in processed network frames buffered in the FIFO 214, or as they are moved to the MAC 224 for transmission for example. For example, for NDD NIC 202 operating to support RFC 3168, the congestion filter 218 may set the relevant bits in the CE FIELD, such as in the IP header of the frames that belong to the flow where congestion has been indicated by the switch, following the setting in the received frames. The congestion indication flags may comprise also on explicit congestion notification (ECN)-echo flags, such as in the TCP header, set by the congestion filter 218. Processed network frames 236 with set congestion indication flags may be transmitted outside the NDD NIC 202 via the MAC block 224 and the PHY block 226, or SerDes, optical or any other media interacting logic or circuitry or interface.

The NDD 203 may continue to send, for this particular flow or flows, processed network frames 236 with set ECN-Echo flags and CE field. When latency is reduced per one embodiment of this invention, it is the NDD NIC 202 that sets and sends frames with theses bits set. The NDD 203 may continue sending such indications, until it receives a TCP segment with a congestion window reduced (CWR) flag set on the same flow. A TCP segment with a set CWR flag may be generated by the network source device, for example, after reduction in rate of frames or bytes per time unit sent by the network source device. Upon detecting a TCP segment with a CWR flag set via the CE filter 222, the NDD NIC 202 may pass the CWR flag to the local TCP engines 212 and 210, in the case the NDD NIC is also a TCP engine. The local TCP engine 210 may reset the transmit side of the TCP receiver 202 and/or the congestion filter 218 via a control bit set on a subsequent transmit frame. In instances when the NDD NIC 202 does not process the TCP/IP layers for the incoming frame, for example when an L2 NIC or connection is not offloaded, the CE filter 222 may pass the indication with the flow identifier to the congestion filter 218.

The host TCP stack 211 may be adapter to send the control bit along with resetting the bits indication congestion. In case the host TCP has not been adapted, the congestion filter 218 may qualify resetting the bits by waiting for host generated frames with congestion bits set, followed by receipt of CWR and then receipt of host frames on the same flow with congestion bits reset. In some instances, CWR indication may be initially received followed by host frames with congestion bits set, followed by host frames with congestion bits reset. Such operation may cause the network destination device to stop sending congestion indication signals to the network source device per this congestion event. The CE filter 222 may be notified as well to ensure it keeps the latest count on available resources in the congestion filter 218. In this regard, by utilizing the CE filter 222 to detect congestion indications and communicate the detected congestion indications to the congestion filter 218, latency within the TCP receiver 202 may be significantly reduced as received network frames 230 may not need to be processed by the receive side logic, FIFO buffers 216, 208, 206, and 214, the TCP engines 212 and 210, and then be subject to latencies in the 214 before being subject to transmission.

In an exemplary embodiment of the invention, some potential race conditions may take place, due to splitting processing of this control information into two locations—the HW and the TCP stack in the NDD NIC 202 or on the host 201. One such case is when an additional congestion event may occur and additional segments with congestion indication, or with a CE bit set, may be received by the network destination device 202 after the reception of a TCP segment with a CWR flag set. The receive (Rx) side of the NDD NICr 202 may be processing the frames and the CE Filter 222 may signal the Congestion Filter 218 to generate indication bits in outgoing frames associated with the flow/connection/class. There are several cases, if the congestion filter 218 on the transmit (Tx) side of the NDD NIC 202 is not yet reset, it may send out ECN-Echo flags with network frames 236. However, such transmission of processed network frames 236 may be due to a continuation for a previous event. This is the case when the local TCP stack didn't yet reset the congestion filter 218 following the reception of the frame with CWR it set for the specific connection/flow/class. When the local TCP resets the congestion filter 218, it stops taking any action for the respective flow and is ready for a new event. After a flush triggered by setting a special control bit as a result of receiving a CWR flag on transmit, any additional CE bit set that is received, may be similar to the first processed event. In this regard, if a reception of a new CE bit set, or a congestion indication, is being reset by the special control bit, as a result of CWR processing, immediately after the CE bit set was received, for a new event, the end point (EP) latency of the TCP receiver 202 may be close to the original latency prior to any processing speed changes. Since CE from the switch may be the result of statistical sampling and processing of a plurality of frames, the probability of such event may be low. In instances when the TCP stack resides on the host 201, a flush indication may not be provided. However, events may then be handled by the hardware, as indicated herein. A more sophisticated mechanism using timing information or TCP sequence numbers may be used to detect such races, but the low probability of the races coupled with the fact that signaling to the network source already took place, reduces the need for it.

In another embodiment of the invention, a race condition may occur if the control loop between hardware and TCP within the NDD NIC 202 or NDD 203 may be longer than the TCP window or Round Trip Time (RTT). In this case, more legitimate events may need to be communicated to the TCP sender on the NSD. However, as the NDD NIC 202 continues to send ECN-Echo flags set within processed network frames 236, no special hardware (HW) treatment may be required. Such a race may be rare as the RTT may comprise latencies on sender, receiver and the network. In this regard, EP latency may be shorter than RTT, unless this is a rare exception.

In yet another embodiment of the invention, another race may occur if the network source has reacted faster than the local TCP stack due to the expedited signaling by the NDD NIC 202 hardware. The NDD NIC 202 hardware may get a frame with a congestion window reduced (CWR) flag set before the local TCP stack 210 and 212 (or the TCP stack on the host for a L2 NIC) has responded to original congestion by setting its own ECN-Echo flag on outgoing data 236. In this case, the TCP receiver 202 hardware may be adapted to continue as before until it may be reset by a special control bit, as disclosed above.

In yet another embodiment of the invention, the TCP engines 210 and 212 may be optional and may be omitted from the NDD NIC 202. In addition, a TCP stack 211 may or may not be utilized within the host processor 201. In the case where the NDD NIC 202 has no TCP/IP functionality, the host networking stack 211 is utilized to react on processing received congestion indication and may be setting its own ECN-Echo flag on outgoing data 236 or any other action based on congestion signaling used.

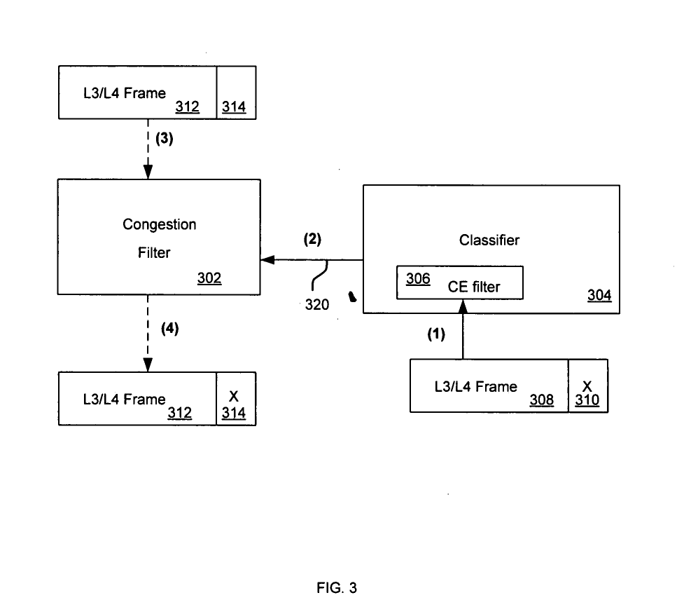

FIG. 3 is a block diagram illustrating handling of congestion notification for L3/L4 frames e.g. TCP/IP, in accordance with an embodiment of the invention. Referring to FIG. 3, the classifier 304, the CE filter 306 and the congestion filter 302 may have the same functionality as the classifier 220, the CE filter 222, and the congestion filter 218 in FIG. 2, respectively. The CE filter 306 within the classifier 304 may be adapted to receive network traffic from the wire, parse it and classify on a flow basis or a class of service (CoS) basis. The CE filter may use some QoS policies in order to decide whether the congestion indicated is in violation or potential violation of a policy and whether it would like to allocate a resource with the congestion filter for this indication to minimize the latency for the indication and/or perform additional functions to ease the potential congestion, such as signal the switch, use alternative method for signaling the NSD, or communicate an indication to a management entity. The CE filter 306 may also notify the driver, a local stack or management entity. The QoS policies may be set by the operating system, by a specific application, by the driver, by an external entity, by management application etc.

In operation, the CE filter 306 within the classifier 304 may receive an L3/L4 frame 308. The L3/L4 frame 308 may comprise congestion indication 310, which may be, for example, an asserted bit or an asserted CE Codepoint of ECN field in the IP header. The congestion indication 320 along with the 4-tuple and/or class of service identifier and other connection parameters may then be communicated to the congestion filter 302. The congestion filter 302 may filter all of the out going frames from the transmit FIFO buffer looking for a frame that belongs to the flow or the CoS signaled by the CE filter 306. When the congestion filter acquires such next processed L4 frame 312 from the transmit FIFO buffer before it is sent to the MAC for transmission, for example, it checks its ECN-echo flag 314 or other indication for example. The processed L4 frame 312 may comprise unasserted ECN-echo flag 314. After the congestion filter 302 processes the L4 frame 312, it may output the processed L4 frame 312 with the ECN-echo flag 314 set, in accordance with the received congestion indication 320. The congestion filter 302 may continue to assert the bit until it is instructed to stop. At this time, the congestion filter 302 may re-arm for the next event from the CE filter 306. The local stack may command the congestion filter 320, to stop after receiving a CWR indication from the networking source device for example or receiving indication from another device or by another signaling mechanism.

In one embodiment of the invention, indication may be received in one protocol layer and may be transmitted it out in a different layer. For instance, the indication may be received in a L3/L4 header or field and may be transmitted out in an L2 header or filed. This may be useful for acceleration of indication with equipment adapted to one layer but not to another, such as a L2 switch with congestion support but without ability to filter or set L3/L4 headers or fields. Locally, the CE filter 306 may communicate the congestion indication it got in one layer in a different layer to a local stack or management entity.

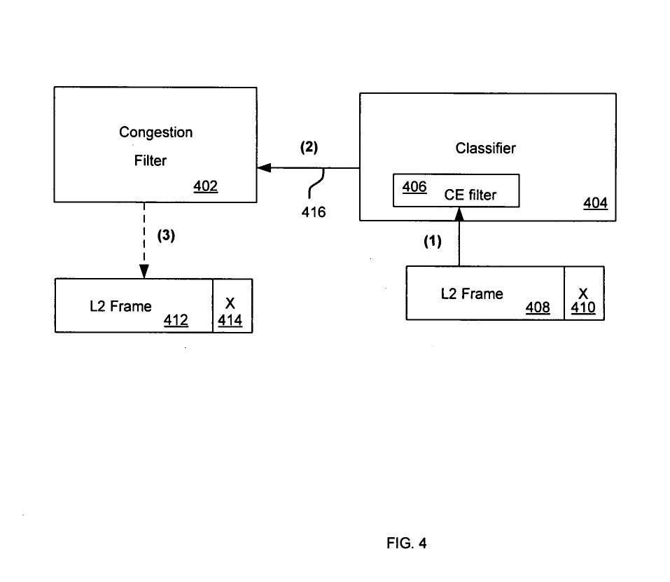

FIG. 4 is a block diagram illustrating handling of congestion notification for L2 frames, in accordance with an embodiment of the invention. Referring to FIG. 4, the classifier 404, the CE filter 406, and the congestion filter 402 may have the same functionality as the classifier 220, the CE filter 222, and the congestion filter 218 in FIG. 2, respectively. The CE filter 406 within the classifier 404 may be adapted to receive network traffic from the same flow or the same class of service (CoS) bucket.

In operation, the CE filter 406 within the classifier 404 may receive an L2 frame 408. The L2 frame 408 may comprise congestion indication 410, which may be, for example, an asserted bit in at least one of the 802.1Q or 802.1P bits or a new Ethernet Type or a dedicated VLAN or a dedicated filed in a Frame extension per the IEEE 802.3as or a dedicated control frame agreed upon by the switch and the NIC or a frame being send to a reserved address or an asserted CE Codepoint of ECN field in the IP header. The CE filter 406 may parse the frames looking for congestion indication for example as listed above. The CE filter 406 may also notify the driver or local stack or management entity or all of the above or any subset thereof. The CE filter 406 may then classify the frame to a flow or Class of Service. Then it may be using some policies (QoS policies for example) to allocate a resource with the congestion filter, as explained herein above. The congestion indication 416 may then be communicated to the congestion filter 402 along with the flow identifier or CoS identifier or both or with more parameters. The congestion filter 402 may generate an indication L2 frame 412. The generated indication L2 frame 412 may comprise an asserted congestion indication in one or more of the 802.1Q or 802.1P bits or a new Ethernet Type or a dedicated VLAN or a dedicated filed in a Frame extension per the IEEE 802.3as or a dedicated control frame agreed upon by the switch and the NIC or a dedicated address and/or using an ECN-echo flag 414. After the congestion filter 402 generates a special L2 frame 412, it may output the L2 frame 412 with the ECN-echo flag 414 set, in accordance with the received congestion indication 416. The congestion filter 402 may generate periodical L2 frames till an indication is received at some layer that the congestion for this particular flow or L2 frames with this particular setting or with this CoS has been addressed.

In yet another embodiment of the invention, the congestion filter 402 may filter one or more of the outgoing frames from the transmit FIFO buffer looking for a frame that belongs to the flow or has the same setting for one or more of the fields identified above, or for the CoS signaled by the CE filter 406. When the congestion filter 402 acquires such next processed L2 or L3 or L4 frame 412 from the transmit FIFO buffer before it is sent to the MAC for transmission, for example, it may output the processed frame 412 with indication bit or bits 414 set at one or more layer. The congestion filter 402 may also set the ECN-echo flag for example, in accordance with the received congestion indication 320. The congestion filter 402 may continue to assert the bit until it receives an instruction to stop. At this time, the congestion filter 402 may re-arm for the next event from the CE filter 406. The local stack may command the congestion filter 402 to stop after receiving an indication from the neighboring switch or from the networking source device, for example, or receiving indication from another device or by another signaling mechanism.

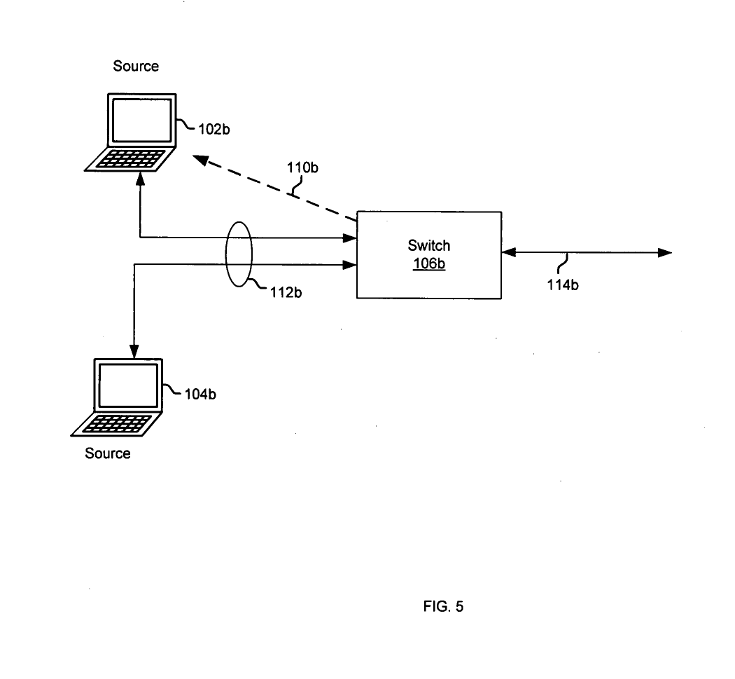

FIG. 5 is a diagram illustrating congestion indication and reaction that is signaled between the switch and the network source device (without a network destination device), and is referred to sometimes as Backend Explicit Congestion Notification (BECN), in accordance with an embodiment of the invention. Referring to FIG. 5, there are illustrated network source devices 102b and 104b, and a network switch 106b. The network source devices 102b and 104b may be PC devices or servers or other networked device connected to the network switch 106b. The network switch 106b may comprise suitable circuitry, logic, and/or code and may be adapted to receive network signals 112b from both network source devices 102b and 104b, and output a network signal 114b selected from the network signals 112b.

In operation, the network switch 106b may experience congestion due to, for example, limitations in the bandwidth of the output network signal 114b or buffer capacity or both. As a result, the network switch 106b may generate a congestion indication 110b, in the backwards direction. Backwards Explicit Congestion Notification (BECN) may be an example for such an action. The network signal 110b may be at any network layer or protocol, for instance L2, or layer 3, or layer 4, or a combination thereof. This congestion indication may be communicated to a stack on the network source device 102b where it may be processed and a reaction may be expected. With regard to the network source device 102b, the latency for FECN-like as well as for BECN-like methods, may comprise the latency on the receive side of the network source device 102b and pipelining, latency associated with stack processing within the network source device 102b, latency associated with taking remedial action such reduction in rate of frames or bytes transmitted in relevant flow or relevant destination or relevant congestion point in the network or class of service, and latency from the transmit side of the network source device 102b, including pipelining.

In an exemplary embodiment of the invention, the response time to congestion indication 110b received by the network source device 102b, for example, may be significantly reduced by reducing latency of the network source device 102b during processing of a congestion indication received from the network switch 106b and by reducing latency associated with any remedial action taken, such as reducing processing speed of unprocessed network frames or by limiting the rate of frames or bytes per time unit and by avoiding additional latencies on the transmit side for instance in pipelining. For example, the network source device 102b may detect congestion indication 110b within network traffic received from the network switch 106b, as early as possible using hardware, logic or processing to identify such an indication, without additional latencies inside the device or on the host in case the protocol stack in charge of processing and/or reacting to the indication reside on the host. The network source device 102b may reduce latency by taking the requested action in response to the congestion.

That action may be rate limiting the transmission of frames that may affect the congested device or may belong to network flow creating or contributing to the congestion or and/or rate limiting the transmission of frames that belong to a more coarse granularity of the affecting traffic, such as class-of-service, TOS, IEEE 802.1P and IEEE802.1Q traffic class, or another type or based or another field in any header at any layer. Another action, in addition to or instead of, may be slowing down the processing of unprocessed network frames, that may belong to network flow creating or contributing to the congestion or to the traffic class in response to the received congestion indication 110b. Such traffic may be placed on a separate transmission queue with per flow or per CoS or other granularity, such as connections belonging to same application, class of applications, or destination, going through a particular hot spot in the network or belonging to one guest operating system in a virtualized environment. Such a queue may be held off from sending new frames or reduce rate or priority as compared with other sources on that source device, till an new indication is received or some time is elapsed or other heuristics to restore transmission rate to some other level. The source behavior for a congestion indication received in a FECN-like, as well as the advantages of shortening the latency of the NSD in the FECN-like cases may be similar to those of the BECN-like cases.

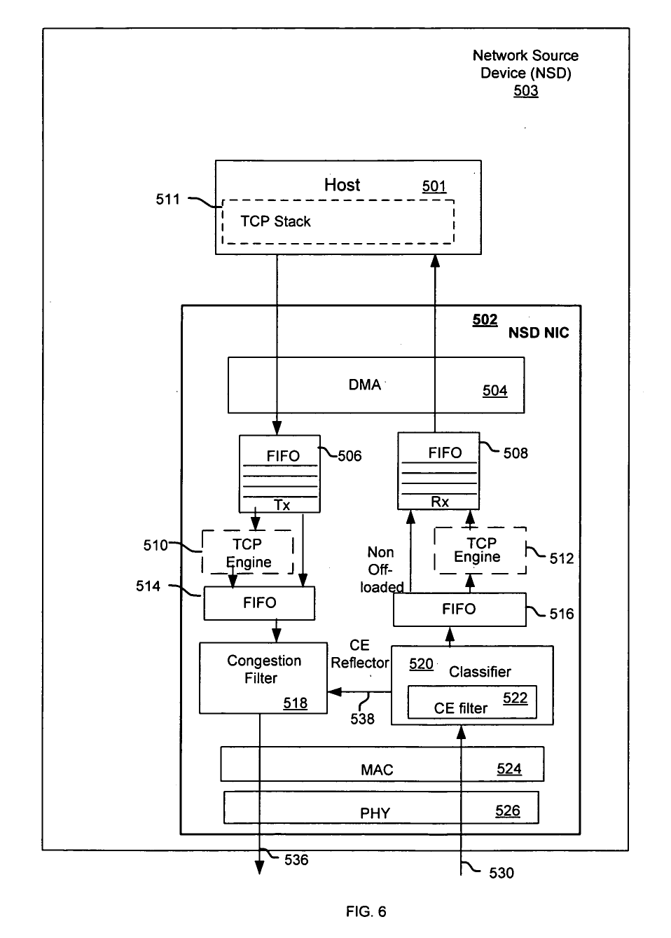

FIG. 6 is a diagram illustrating an exemplary fast congestion handling source such as a network source device (NSD), in accordance with an embodiment of the invention. Referring to FIG. 6, the NSD NIC 502 may be implemented within a network source device (NSD) 503, for example, and may comprise a network protocol stack for processing network data. The NSD NIC 502 may comprise a physical layer (PHY) block 526, a data link layer or media access control (MAC) block 524, a classifier block 520, first-in-first-out (FIFO) buffers 506, 508, 514, and 516, TCP engine blocks 510 and 512, a congestion filter 518, and a direct memory access (DMA) block 504. The classifier block 520 may comprise a congestion experience (CE) filter 522.

The classifier block 520 may comprise suitable circuitry, logic, and/or code and may be adapted to match incoming network frames with one or more active connections owned by the networking source device 503, regardless of whether TCP stack is on the NIC or on the host. The CE filter 522 may comprise suitable circuitry, logic, and/or code and may be adapted to parse incoming frames, classify them to a particular flow, CoS, etc., filter congestion indications within incoming network frames, employ policies, such as QoS, to decide if expedited action is required and whether suitable resources are to be allocated by the congestion filter 518 and communicate the congestion indications to the congestion filter 518 and optionally to the driver, network stack and/or to a management entity. The congestion filter 518 may comprise suitable circuitry, logic, and/or code and may be adapted to parse outgoing frames, associate them with particular flow or connection or CoS or a combination, reduce latency for network source device responding to network congestion by rate limiting the processing or transmission of network frames within the NSD NIC 502 down to a given frames or bytes per unit time. It may also drop frames queued for transmission before they are transmitted to the network, with or without notifying the local stack of such action.

Depending on the action the congestion filter 518 may take, it may need to obtain the parameters of the new rate required for congestion reduction. In instances where the mechanism is on a per flow basis, flow specific parameters may be needed. For example, for a TCP flow, the congestion window may be reduced to half its previous size. Such an action may be taken once per round Trip Time (RTT). Hence, the congestion filter 518 may need to acquire the parameters and time stamp of last rate reduction to ensure it is not aggressive. In case the NSD NIC 502 owns the TCP connection, it may require accessing the context memory where the connection parameters are held. In instances when the connection is managed by the host stack, the host stack may be adapted to allow the NSD NIC 502 to look up and access the relevant parameters or the host stack may make the parameters available to the NIC or the device may use estimation of the RTT along with time stamps to approximate the next event rate reduction. Estimation may be performed based on information gathered from the frames received and transmitted or using external information, such as configuration or administrator's input.

In instances of congestion handling based on CoS or another policy, the QoS parameters, such as rates and association to a CoS may be communicated to the NSD NIC 502 and to the congestion filter 518. The congestion filter 518 may use the information and may apply the policy to the outgoing frames. For example, in instances when a frame belongs to a particular CoS and the congestion indication received applies to that CoS or a rate limitation or reduction is already in place for the particular CoS, the congestion filter 518 may apply the current congestion limiting policy to these outgoing frames.

In operation, received network data 530 may be initially processed by the PHY block 526 and by the MAC block 524. The CE filter 522 within the classifier block 520 may then parse, classify and detect congestion indication on the received network data 530. The CE filter 522 may use the policies and decide whether to forward the detected congestion indication 538 to the congestion filter 518 on the transmit side of the NSD NIC 502. In response to the received congestion indication 538, the congestion filter 518 may filter out, or “drop,” processed network frames which may be stored in the FIFO 514. In one embodiment of the invention, the congestion filter 518 may be adapted to filter processed network frames which are of the same type, such as L2 or L4, for example, or the same class of service (CoS) bucket as the received network frames 530. In this regard, by filtering processed network frames, the NSD NIC 502 may reduce processing latency. Furthermore, the stack within the NSD NIC 502 may adjust transmission rate and/or other parameters, such as TCP congestion window. The stack and hardware may utilize a handshake mechanism to ensure that there are no race conditions. For example, when the stack has acted upon a received congestion indication, hardware resources within the NSD NIC 502 may be freed up. The rate limiting policy may be achieved by queuing the frame or frames for some time, applying “leaky bucket” or another algorithm as appropriate. This may require significant additional buffering. Another option is by allowing the congestion filter 518 to skip frames queued up in the FIFO 514 and skipping all the frames that are not ready for transmission due to the congestion handling.

In another embodiment of the invention, the frames that have been determined to belong to affected flows or CoS or have impact over the network congestion, such as by going through the same hot spots or same output buffers in the host spots, may be dropped. This may require some retransmit by the relevant layer on the NSD NIC or the NSD host. This retransmission may be triggered by an indication form the NDD receiver of missed frames, such as TCP ACK with last sequence number received in order. This may affect the performance of impacted flows. Another option is to drop the frames and notify the local stack that such action took place. This may trigger local transmission similar to what is done for a regular retransmit but now the performance impact on the flow may be limited. With these 2 options, the congestion filter may have no need to acquire any additional specific setting state or parameters of the affected flows or CoS. This policy may be in effect till the local stack provides an indication to the congestion filter that it has acted on the event, such as by sending a special control information or by setting CWR on an outgoing frame that belongs to the affected flow or by sending another indication to the congested resource or to the network or to the NDD.

Once the congestion filter 518 receives a frame for transmission on the Tx flow with a congestion window reduced (CWR) flag or one of the above indications set, it may stop dropping packets and it may notify the local stack on the host 501 or/and the TCP engines 510 and 512 and/or the CE filter that it stopped filtering. In order to re-arm the hardware mechanism for this flow, the TCP engine 510 or 512 or the host stack 511 or another communication stack that may own the flow within the NSD 503 may be adapted to separately signal the hardware that it has acted on previous event and is ready to act again for the current flow. Accordingly, in a future transmitted frame a control bit may be added which may be used for resetting processing speed.

In another embodiment of the invention, the congestion filter 518 may be adapted to notify the local network stack or the host stack 511 or the TCP engine 510 and/or 512 when the filtering or any other action specified above of processed network frames to be transmitted is complete. Completion of network frames filtering may be triggered by detection of a control bit, for example, within received network frames 530, or by detection of unasserted congestion indication, such as unasserted ECN-echo flag. After completion of network frames filtering by the congestion filter 518, output of processed network frames 536 may resume as normal.

Exemplary hardware transmit behavior for the NSD NIC 502 may be represented by the following pseudo code:

For Flow X or CoS Y,
If armed and Receive a Congestion indication (e.g. a CE)—GO TO DROP i.e. drop Flow X's or CoS Y's frames queued up for transmission
If in DROP state and receive first indication from local stack (e.g. CWR set in an outgoing frame for Flow X or CoS Y)—GO to WAIT state i.e. stop dropping and keep Flow X identifier or CoS Y identifier, wait for a re-arm
If in WAIT state and receive a new Congestion indication (e.g. a CE)—ignore
If in WAIT state and get a second signal from local stack or HW timer expired—free resources (e.g. flow identifier, CoS identifier, filter), ready for a new CE

DROP in the above state machine may utilize execution of the congestion limiting policy, as described herein above. The first and second indication may be sent in one message. The hardware may maintain a timer to measure approximate RTT using actual connection parameters or pre-configured value, such as an estimate of a data center RTT.

In another embodiment of the invention, which may be exemplified for RFC 3168, additional CE events may be received by the NSD NIC 502 after a CWR is sent with outgoing network frames 536. The hardware may not know whether this is a new legitimate congestion event and, therefore, it may take immediate action in hardware such as drop frames scheduled for transmission or rate limit them or just a trailer of the previous event. A determination may then be made as to whether the CE event falls inside the TCP window (RTT) or outside the TCP window (RTT) of the particular flow. If it falls within the TCP window, it may be ignored. Otherwise, if it falls outside the TCP window, it may constitute a new event and may not be ignored—the stack may process it as the hardware may be in WAIT state to avoid the case where it acts too aggressive (e.g. drop rate more than once per RTT) and the stack may later re-arm the hardware. For other events such as dropped frame with CWR set, which may require retransmission, the hardware may mistake the re-transmitted frame with CWR as a new indication from the stack. In instances when the local stack is adapted to signal the hardware, it may qualify CWR with a flag to denote this case. If not, the hardware may utilize an RTT timer (or estimated RTT) to qualify the CWR, relating to CWR within the window only. In some instances, the hardware may already be in WAIT state after first CWR was sent, and hence the re-transmit may not affect its behavior. New events when the hardware is not armed may get a slower response. In another embodiment of the invention, if the hardware has no resources, and the local stack started processing, then the hardware may free up resources, catch a CE received frame and may starts “dropping” or rate adjusting on top of the action by the stack. The first CWR transmitted may be adapted to stop the rate adjusting.

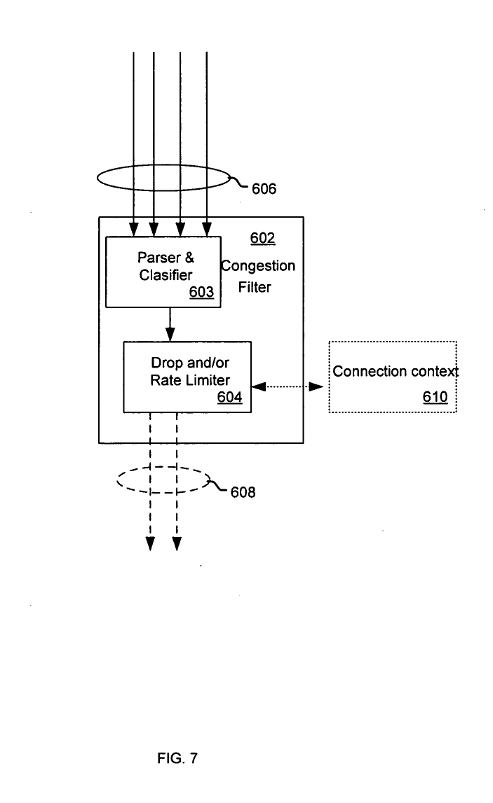

FIG. 7 is a block diagram of exemplary congestion filter, in accordance with an embodiment of the invention. Referring to FIG. 7, the congestion filter 602 may comprise a parser and a classifier 603 and a rate limiter 604. The congestion filter 602 may have the same functionality as the congestion filter 518 in FIG. 5, for example. The parser and classifier 603 may comprise suitable circuitry, logic and/or code and may be adapted to classify frames to be transmitted, associate those frames with a flow and/or CoS. For the frames that are associated with flows where the congestion filter 518 has state indicating actions to be taken on these frames, it may drop the frames, drop and notify local stack (on NSD NIC or in the NSD host) or rate limit them. The rate limiter 604 may comprise suitable circuitry, logic, and/or code and may be adapted to reduce the rate of processing of network frames by the congestion filter 602 or simply drop them or drop with an appropriate indication provide tot the local stack. For example, a plurality of network frames 606 may be communicated to the congestion filter 602 for processing. The plurality of frames 606 may comprise network frames which may be processed by a TCP protocol stack, such as the TCP engine 510 in FIG. 6. The rate limiter 604 may limit the number of processed network frames that are being communicated as output 608 of the congestion filter 602. In such instances, the rate limiter 604 may obtain state (for instance RTT, time elapsed from last rate reduction) and setting information from the connection context block 610. In this regard, the rate limiter 604 may drop one or more of the frames associated with an affected flow or CoS.

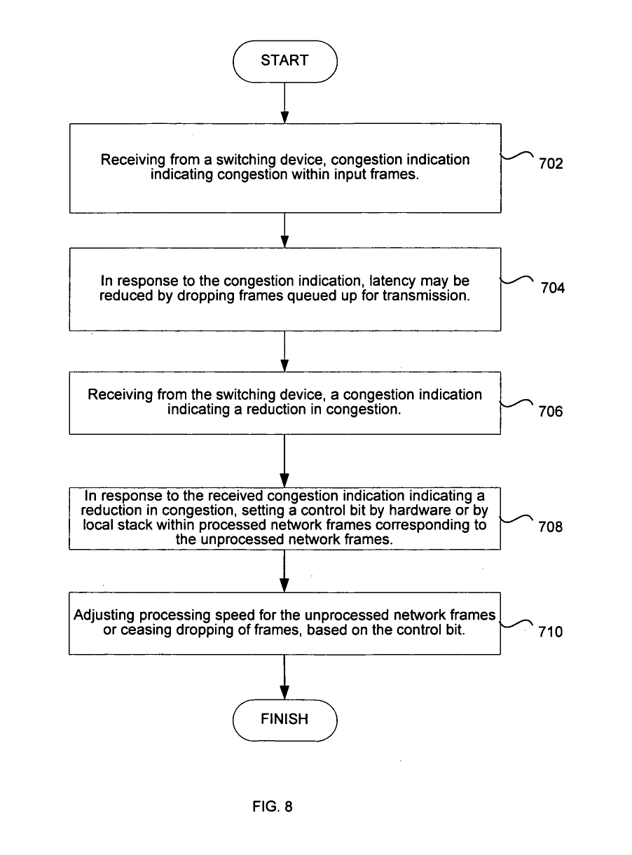

FIG. 8 is a flow diagram illustrating exemplary steps for processing network data at the network source device, in accordance with an embodiment of the invention. Referring to FIGS. 1, 5, 6 and 8, for both cases where FECN like or BECN like is employed and for signaling at L3, L4, or L2 or any combination thereof, at 702, a congestion indicator representative of congestion may be received by the CE filter 522 within input frames 530. The input frames 530 may be received from a routing or a switching device, for example. The CE filter may transfer the indication along with flow identifier and other parameters to the Congestion filter. At 704, in response to the received congestion indicator, latency may be reduced by dropping frames queued up for transmission or by rate limiting the processing of unprocessed network frames in hardware. This may be performed by a congestion filter within a network source device, such as the congestion filter 518 in FIG. 6. All subsequent frames queued up for transmission for the affected flow/s or CoS. The NSD may continue to do it, till its local stack has taken remedial action or some time (e.g. RTT) has elapsed or new information is provided from the network. At 706, a congestion indicator that indicates a reduction in congestion may be received from a switching device. At 708, in response to the received congestion indicator 538 that indicates a reduction in congestion, a control bit may be set by hardware or by the local stack within processed network frames 536 corresponding to the unprocessed network frames 530. At 710, processing speed may be adjusted for the unprocessed network frames or drop is stopped, based on the control bit. The adjustment of processing speed may be performed by a congestion filter within a network source device, such as the congestion filter 518 in FIG. 5.

In yet another embodiment of the invention, the TCP engines 510 and 512 may be optional and may be omitted from the NSD NIC 502. In addition a host networking stack, such as a TCP/IP stack 511, may or may not be utilized within the host processor 501. In instances when the NSD NIC 502 has no TCP/IP functionality, the host networking stack 511 may be utilized to react on processing received congestion indication and may be adjusting the transmission rate, generating its own CWR flag or other signal on outgoing data 236 or any other action based on congestion signaling used. The host networking stack may assume all the roles the TCP engines 510 and 512 have assumed.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing network data, the method comprising: in response to receiving a congestion indicator, reducing latency by rate limiting the processing of outgoing frames related to congestion without intervention from a protocol stack.

2. The method according to claim 1, further comprising eliminating from a queue for said rate limiting, at least a portion of said return frames.

3. The method according to claim 1, further comprising controlling output to a wired medium for said rate limiting.

4. The method according to claim 1, further comprising selecting a particular flow associated with at least one of said outgoing frames for said rate limiting.

5. The method according to claim 1, further comprising selecting a particular class of service associated with at least one of said outgoing frames for said rate limiting.

6. The method according to claim 1, further comprising establishing a policy that identifies at least one of the following: a particular flow and a particular Class of Service (CoS) associated with at least one of said return frames for said rate limiting.

7. The method according to claim 1, further comprising, in response to receiving said congestion indication which identifies congestion for a particular flow, reducing a rate for other flows into a congested device.

8. A method for processing network data, the method comprising: in response to receiving a network congestion indicator, notifying a source device that a particular flow associated with said source is experiencing congestion, without intervention from a protocol stack.

9. The method according to claim 8, further comprising notifying said source device that a particular Class of Service (CoS) associated with said source is experiencing congestion, without intervention from a protocol stack.

10. The method according to claim 8, further comprising generating a new message for said notifying.

11. A system for processing network data, the system comprising circuitry that enables reduction of latency by rate limiting the processing of outgoing frames related to congestion without intervention from a protocol stack, in response to receiving a congestion indicator.

12. The system according to claim 11, wherein said circuitry enables eliminating from a queue for said rate limiting, at least a portion of said return frames.

13. The system according to claim 11, wherein said circuitry enables controlling of output to a wired medium for said rate limiting.

14. The system according to claim 11, wherein said circuitry enables selection of a particular flow associated with at least one of said outgoing frames for said rate limiting.

15. The system according to claim 11, wherein said circuitry enables selection of a particular class of service associated with at least one of said outgoing frames for said rate limiting.

16. The system according to claim 11, wherein said circuitry enables establishing of a policy that identifies at least one of the following: a particular flow and a particular Class of Service (CoS) associated with at least one of said return frames for said rate limiting.

17. The system according to claim 11, wherein said circuitry enables reducing of a rate for other flows into a congested device, in response to receiving said congestion indication which identifies congestion for a particular flow.

18. A system for processing network data, the system comprising circuitry that enables notifying of a source device that a particular flow associated with said source is experiencing congestion, without intervention from a protocol stack and in response to receiving a network congestion indicator.

19. The system according to claim 18, wherein said circuitry enables notification of said source device that a particular Class of Service (CoS) associated with said source is experiencing congestion, without intervention from a protocol stack.

20. The system according to claim 18, wherein said circuitry enables generation of a new message for said notifying.

21. A machine-readable storage having stored thereon, a computer program having at least one code section for processing network data, the at least one code section being executable by a machine for causing the machine to perform steps comprising: in response to receiving a congestion indicator, reducing latency by rate limiting the processing of outgoing frames related to congestion without intervention from a protocol stack.

22. The machine-readable storage according to claim 21, further comprising code for eliminating from a queue for said rate limiting, at least a portion of said return frames.

23. The machine-readable storage according to claim 21, further comprising code for controlling output to a wired medium for said rate limiting.

24. The machine-readable storage according to claim 21, further comprising code for selecting a particular flow associated with at least one of said outgoing frames for said rate limiting.

25. The machine-readable storage according to claim 21, further comprising code for selecting a particular class of service associated with at least one of said outgoing frames for said rate limiting.

26. The machine-readable storage according to claim 21, further comprising code for establishing a policy that identifies at least one of the following: a particular flow and a particular Class of Service (CoS) associated with at least one of said return frames for said rate limiting.

27. The machine-readable storage according to claim 21, further comprising code for reducing a rate for other flows into a congested device, in response to receiving said congestion indication which identifies congestion for a particular flow.

28. A machine-readable storage having stored thereon, a computer program having at least one code section for processing network data, the at least one code section being executable by a machine for causing the machine to perform steps comprising: in response to receiving a network congestion indicator, notifying a source device that a particular flow associated with said source is experiencing congestion, without intervention from a protocol stack.

29. The machine-readable storage according to claim 28, further comprising code for notifying said source device that a particular Class of Service (CoS) associated with said source is experiencing congestion, without intervention from a protocol stack.

30. The machine-readable storage according to claim 28, further comprising code for generating a new message for said notifying.
